(19) United States
(12) Patent Application Publication
(10) Pub. No.: US 2011/0165291 A1
(43) Pub. Date: Jul. 7, 2011

(54) NUTRITIONAL SUPPLEMENT

(76) Inventors: Andrew Loblaw, Toronto (CA); Nancy Partridge, Delray Beach, FL (US)

(21) Appl. No.: 13/062,909

(22) PCT Filed: Nov. 12, 2009
(86) PCT No.: PCT/US2009/006069

§ 371 Date: Mar. 8, 2011

Related U.S. Application Data
(60) Provisional application No. 61/193,263, filed on Nov. 12, 2008.

(51) Int. Cl. A23L 1/303; A23L 1/304

(52) U.S. Cl. 426/73; 426/72

(57) ABSTRACT

The nutritional supplement is a combination of several nutrients, including vitamins, minerals, and antioxidants, that are preferably delivered in the form of a caplet, i.e., a smooth, coated, oval-shaped tablet intended to be tamper-proof. The nutrient ingredients include effective amounts of vitamin D, vitamin E (alpha-tocopherol), zinc, selenium, eicosapentaenoic acid (EPA), docosahexaenoic acid (DHA), capsaicin, curcumin, and lycopene. The ingredients are believed to act in various synergistic combinations of active ingredients, or active ingredients in combination with agents that increase absorption and metabolism of the active ingredients. The combined ingredients, delivered in caplet form, correct dietary deficiencies of these nutrients, and are believed to be effective in preventing the incidence of certain cancers, or in slowing the growth or progression of the cancers.

### TECHNICAL FIELD

The present invention relates to dietary supplements, and particularly to a nutritional supplement that provides several nutrients that are frequently absent from the diet, or are low in the diet, and that particularly includes several nutrients that are believed to be effective in slowing the growth of cancer or preventing the incidence of cancer either alone or when taken in combination.

### BACKGROUND ART

According to the American Cancer Society® (American Cancer Society is a registered trademark of the American Cancer Society, Inc. of Atlanta, Georgia), cancer was the second leading cause of death both worldwide and in developed countries. Although some forms of cancer are genetic, it is thought that other forms of cancer are related to environmental factors, including diet, activity level, stress, environmental toxins, etc. It has been estimated that up to one-third of deaths due to cancer can be related to deficiencies in diet and activity levels.

It has been recommended, both by the ACS and other sources, that the daily diet of healthy individuals includes five servings of fruits and vegetables, three servings of whole grains, and reduced servings of red or processed meats. Such foods include vitamins, minerals, and antioxidants that are believed to prevent the incidence of cancer, or to slow its growth. Persons already afflicted with cancer, undergoing chemotherapy, or recuperating from surgery or chemotherapy for cancer also have special nutritional needs that require maintaining adequate levels of vitamins, minerals, and antioxidants, but also require caution in not taking supplements that have too high a level of these substances that may have an adverse affect on their cause of treatment.

Nevertheless, in spite of these recommendations, lifestyles in developed countries often revolve around the fast food diet, with low levels of fresh foods, fruits, vegetables, and whole grains, and with high levels of red or processed meats and fats. Consequently, many persons have low levels or deficiencies of several vitamins, minerals, antioxidants, and other nutrients that statistical studies have shown to be linked to lower incidence of certain types of cancer, or to slower growth or progression of these cancers. Thus, a nutritional supplement solving the aforementioned problems is desired.

### DISCLOSURE OF INVENTION

The nutritional supplement is a combination of several nutrients, including vitamins, minerals, and antioxidants, that are preferably delivered in the form of a caplet, i.e., a smooth, coated, oval-shaped tablet intended to be tamper-proof. The nutrient ingredients include effective amounts of vitamin D, vitamin E (alpha-tocopherol), zinc, selenium, eicosapentaenoic acid (EPA), docosahexaenoic acid (DHA), capsaicin, curcumin, and lycopene. The ingredients are believed to act in various synergistic combinations of active ingredients, or active ingredients in combination with agents that increase absorption and metabolism of the active ingredients. The combined ingredients, delivered in caplet form, correct dietary deficiencies of these nutrients, and are believed to be effective in preventing the incidence of certain cancers, or in slowing the growth or progression of the cancers.

These and other features of the present invention will become readily apparent upon further review of the following specification.

### BEST MODES FOR CARRYING OUT THE INVENTION

The nutritional supplement is a combination of nutrients that are often absent from the diet, or only present at low levels in the diet, and that are believed to be effective in either preventing the incidence of certain forms of cancer, or in slowing the growth or progression of these cancers. The nutrients are delivered for oral administration, preferably in the form of a caplet, i.e., a smooth, coated, oval-shaped tablet intended to be tamper-proof.

Each caplet contains an effective amount of the following nutrients: vitamin D; vitamin E (alpha-tocopherol); zinc; selenium; eicosapentaenoic acid (EPA); docosahexaenoic acid (DHA); capsaicin; curcumin; and lycopene. A preferred dose per caplet and acceptable dosage range for each ingredient is shown in Table I.

| Ingredient | Dose | | Range | |
|---|---|---|---|---|
| Vitamin D | 400 | IU | 200-2000 | IU |
| Vitamin E | 400 | IU | 15-400 | IU |
| Zinc | 15 | mg | 10-100 | mg |
| Selenium | 200 | mcg | 55-400 | mcg |
| EPA | 500 | mg | 250-1000 | mg |
| DHA | 500 | mg | 250-1000 | mg |
| Capsaicin | 55 | mg | 5-250 | mg |
| Curcumin | 50 | mg | 50-1000 | mg |
| Lycopene | 20 | mg | 20-1000 | mg |

Vitamin D is most widely known for its ability to regulate blood serum levels of calcium and phosphorus. However, some studies have indicated that vitamin D may have a role in helping to prevent prostate, colon, and breast cancer. See, for example, the study reported by Lappe et al. in 85 Am. J. Clin. Nutr. 1586-1591 (2007), which reports that in a three-arm (1400-1500 mg supplemental calcium/day alone (Ca-only), supplemental calcium plus 1100 IU vitamin D3/d (Ca_D), or placebo), double-blind, randomized, placebo-controlled trial of 1179 women, cancer incidence was significantly reduced in those randomized to Ca_only or Ca_D. Cancer incidence after twelve months was only observed in patients randomized to the Ca_D arm. Also, as reported by Woo et al. in Nutr. Cancer, 51(1):32-36 (2005), in a small study of men with progressive, androgen-dependent, non-metastatic prostate cancer, 93% of men taking 2000 IU of vitamin D had prolonged PSA doubling times (slower growth of tumors) and 60% had a reduction or leveling off of their PSA levels. Normally the body produces sufficient vitamin D with sufficient exposure to sunlight, and with drinking milk, which is often fortified with vitamin D. However, studies have shown shortages in vitamin D levels due to inadequate exposure to sunlight, not including milk in the diet, and decreased ability to produce vitamin D after age 50. The United States Department of Agriculture (USDA) Recommended Dietary Allowance (RDA) for vitamin D is 200 IU for persons under age 50, 400 IU for persons age 50 to age 70, and 600 IU for persons over age 70, although there has been some speculation that these values may be too low. The nutritional supplement preferably includes about 400 IU of vitamin D, but may include anywhere from 200 to 2,000 IU of vitamin D.

Vitamin E (alpha-tocopherol) is well known as a powerful antioxidant. Although oxygen is necessary for proper metabolism, sometimes oxygen is present in harmful forms, such as ozone or free radicals, which can damage cells. Antioxidants scavenge the body's systems, reducing free radicals to harmless forms. In one study of male smokers, those who took about 50 mg per day of alpha-tocopherol had about 32-41% decreased mortality from prostate cancer. The RDA for alpha-tocopherol is about 12-15 IU per day, although this amount is not large enough to achieve powerful antioxidant effects. Vitamin E is only present in a few foods, notable wheat germ, vegetable oils, and some nuts and seeds, so that dietary supplement is often required to obtain the beneficial antioxidant effects of Vitamin E. The nutritional supplement preferably includes about 400 IU of vitamin E, but may contain between 15 and 400 IU of vitamin E.

Zinc is a mineral essential to every cell in the body, and affects a wide range of systems. Zinc has been shown to influence apoptosis (programmed cell death), as well as protein kinase C activity (an inflammatory marker). It is believed that zinc may be necessary for immunocompetence, and therefore indirectly benefits slowing the growth of cancer through action of the immune system. Zinc may be obtained through drinking water or some meats, and some nuts, particularly almonds. However, the nutritional supplement preferably contains about 15 mg of zinc, but may contain between 10 and 100 mg of zinc.

Selenium is a trace mineral found in some organs of the body. A five-year study at Cornell University and the University of Arizona showed that 200 mcg of selenium daily resulted in 63% fewer prostate tumors, 58% fewer colorectal cancers, 46% fewer lung malignancies, and 39% overall decrease in cancer fatalities. Other studies have shown correlations between low levels of selenium and the incidence of other forms of cancer. See The Healing Power of Vitamins, Minerals, and Herbs, published by the Reader's Digest Association, Inc. in 1999, p. 352. Selenium is available in the diet through poultry, seafood, meats, and some grains. The RDA for selenium is about 55 mcg, but much more may be needed to achieve major benefits. The nutritional supplement preferably contains about 200 mcg of selenium, but may contain between 55 mcg and 400 mcg of selenium.

Eicosapentaenoic acid (more formally, cis-5,8,11,14,17 eicosapentaenoic acid, also referred to as EPA) is a 20-carbon omega-3 essential fatty acid, and docosahexaenoic acid (all-cis-4,7,10,13,16.19 hexaenoic acid, or DHA) is a 22-carbon omega-3 essential fatty acid.

EPA is thought to be the precursor of a class of eicosanoids, including prostaglandins and leukotrienes, which have the effect of suppressing neutrophils and tumor necrosis factor, thereby reducing the immune system response, including edema and tissue destruction, with consequent reduction in pain. Both EPA and DHA have been shown to decrease the risk of prostate cancer, and DHA has also been shown to decrease the risk of colorectal cancer. Fish oil is a natural source of EPA and DHA. The nutritional supplement preferably contains about 500 mg each of EPA and DHA, but may contain between 250 mg and 1,000 mg each of EPA and DHA.

Capsaicin is the active ingredient in cayenne pepper, also known as chili pepper or red hot pepper. Cayenne pepper typically contains only about 1.5% capsaicin. The nutritional supplement does not contain cayenne pepper, but only the isolated and purified active ingredient, capsaicin. Although test data in humans is limited, animal studies have shown slowed prostate cancer growth with oral administration of capsaicin, and testing in at least one human has similarly shown slowed growth of prostate cancer. Capsaicin is also known to suppress the mutagenicity of cigarette smoke condensates and several other common mutagens. The nutritional supplement preferably contains about 55 mg of capsaicin, but may include between 5 and 250 mg of capsaicin.

Curcumin is an antioxidant that is obtained from the herb “turmeric”, a member of the ginger family, which contains 0.3-5.4% curcumin. Curcumin exerts greater antioxidant effect against hydroxyl radicals than vitamin C and vitamin E, and several studies have suggested that curcumin is effective against all stages of cancer, including initiation, promotion, and progression. See Murray, The Healing Power of Herbs, Prima Publishing (1995), pp.328-329. The nutritional supplement preferably contains about 50 mg curcumin, but may contain between 50 mg and 1,000 mg of curcumin.

Lycopene is a carotenoid present in tomatoes. Lycopene is an antioxidant. Recent studies have shown that lycopene may inhibit the formation of prostate cancer, and may also be effective against cancers of the stomach and digestive tract. The nutritional supplement preferably contains about 20 mg of lycopene, but may contain between 20 mg and 1,000 mg of lycopene.

In addition to their individual antioxidant effects, some studies have suggested that various combinations of the ingredients of the nutritional supplement may act in concert to produce a synergistic effect that is more powerful than the individual action of the ingredients. For example, some studies have shown that not only does selenium exert a greater antioxidant effect when taken in combination with vitamin E (alpha-tocopherol), but the same combination may help to inhibit the formation of prostate cancer, and in combination with lycopene, may slow the growth of cancer. Further, studies have shown that DHA and EPA are more effective in inhibiting tumor growth when taken in combination with vitamin D.

The nutritional supplement is preferably provided as a caplet for oral administration. The coated caplet provides a more palatable mode for administration of the combined ingredients, particularly in view of the capsaicin component, which might otherwise cause discomfort to the oral mucosa. Thus, the nutritional supplement redresses dietary insufficiencies in several important vitamins, minerals, and antioxidants, and provides a cocktail of natural ingredients that, when taken alone or in combination, may have some effectiveness in preventing the formation or slowing the growth of certain forms of cancer.

It is to be understood that the present invention is not limited to the embodiments described above, but encompasses any and all embodiments within the scope of the following claims.

We claim:

1. A nutritional supplement, comprising a composition containing:
capsaicin;
at least one vitamin;
at least one mineral; and
at least one fatty acid.

2. The nutritional supplement according to claim 1, wherein said composition is formulated as a caplet for oral administration.

3. The nutritional supplement according to claim 1, wherein said at least one vitamin comprises at least one vitamin selected from the group consisting of vitamin D and vitamin E

4. The nutritional supplement according to claim 1, wherein said at least one mineral comprises at least one mineral selected from the group consisting of zinc and selenium.

5. The nutritional supplement according to claim 1, wherein said at least one fatty acid comprises at least one fatty acid selected from the group consisting of eicosapentaenoic acid and docosahexaenoic acid.

6. The nutritional supplement according to claim 1, wherein said composition further comprises curcumin.

7. The nutritional supplement according to claim 1, wherein said composition further comprises lycopene.

8. The nutritional supplement according to claim 1, wherein said composition further comprises curcumin and lycopene.

9. The nutritional supplement according to claim 1, wherein said composition comprises:
between about 5 mg and 250 mg capsaicin;
between about 200 IU and 2000 IU vitamin D;
between about 15 IU and 400 IU vitamin E;
between about 15 mg and 100 mg zinc;
between about 55 mcg and 400 mcg selenium;
between about 250 mg and 1000 mg eicosapentaenoic acid; and
between about 250 mg and 1000 mg docosahexaenoic acid.

10. The nutritional supplement according to claim 9, further comprising:
between about 50 mg and 1000 mg curcumin; and
between about 20 mg and 1000 mg lycopene.

11. The nutritional supplement according to claim 1, wherein said composition comprises:
about 55 mg capsaicin;
about 400 IU vitamin D;
about 400 IU vitamin E;
about 15 mg zinc;
about 200 mcg selenium;
about 500 mg eicosapentaenoic acid;
about 500 mg docosahexaenoic acid
about 50 mg curcumin; and
about 20 mg lycopene.

12. A nutritional supplement, consisting essentially of:
vitamin D;
vitamin E;
zinc;
selenium;
eicosapentaenoic acid;
docosahexaenoic acid;
capsaicin;
curcumin; and
lycopene.

13. The nutritional supplement according to claim 12, wherein said composition consists essentially of:
between about 5 mg and 250 mg capsaicin;
between about 200 IU and 2000 IU vitamin D;
between about 15 IU and 400 IU vitamin E;
between about 15 mg and 100 mg zinc;
between about 55 mcg and 400 mcg selenium;
between about 250 mg and 1000 mg eicosapentaenoic acid;
between about 250 mg and 1000 mg docosahexaenoic acid;
between about 50 mg and 1000 mg curcumin; and
between about 20 mg and 1000 mg lycopene.

14. The nutritional supplement according to claim 12, wherein said composition consists essentially of:
about 55 mg capsaicin;
about 400 IU vitamin D;
to about 400 IU vitamin E;
about 15 mg zinc;
about 200 mcg selenium;
about 500 mg eicosapentaenoic acid;
about 500 mg docosahexaenoic acid about 50 mg curcumin; and
about 20 mg lycopene.

15. The nutritional supplement according to claim 12, wherein said composition is formulated as a caplet for oral administration.
